(19) United States
(12) Patent Application Publication
(10) Pub. No.: US 2003/0031213 A1
(43) Pub. Date: Feb. 13, 2003

(54) Device and method for setting up standby paths in a transport network for dual homing

(76) Inventors: Joachim Charzinski, Oberschleissheim (DE); Dominic Axel Schupke, Muenchen (DE)

Correspondence Address: Bell, Boyd & Lloyd LLC, P.O. Box 1135, Chicago, IL, 60690, US

(21) Appl. No.: 10/216,149

(22) Filed: Aug. 9, 2002

(30) Foreign Application Priority Data
Aug. 9, 2001 (DE) 101 39 156.0

(51) Int. Cl. H04J 3/02; H04L 12/28; H04L 12/56

(52) U.S. Cl. 370/539

(57) ABSTRACT

Provided are a transceiver for use in an optical communication network, an optical information transmission method, and an optical communication network in which optical signals are transferred via a first data connection from a first transceiver to a second transceiver via a number of interconnected network node devices, wherein in order to set up a second data connection between first and second transceivers, there is sent from the first transceiver to the network node device connected to the first transceiver a data connection setup signaling signal in which information referring to the desired course of the second data connection is included.

### BACKGROUND OF THE INVENTION

The present invention relates, generally, to an optical communication network, a transceiver for use in such an optical communication network and to an optical information transmission method.

Optical communication networks generally exhibit a first transceiver from which optical signals are transmitted via a data connection to a second transceiver with the interposition of a number of interconnected network node devices. The network node devices can be interconnected, in each case, via one or more optical conductors, for example.

Within the communication network, data can be transmitted, for example, with the aid of optical WDM (wavelength division multiplex) binary signals. In this arrangement, a number of wavelength-division-multiplexed pulsed optical signals can be transmitted via a single optical conductor.

It is possible to provide in the communication network a central control device, for example, that upon the occurrence of disturbances causes the first data connection from then on to transmit the optical signals emitted by the first transceiver via a second data connection, differing from the first data connection.

It is an object of the present invention to make available a novel optical communication network, a novel transceiver for use in an optical communication network and a novel optical information transmission method.

### SUMMARY OF THE INVENTION

According to a basic concept of the present invention, an optical communication network is provided in which optical signals are transferred via a first data connection from a first transceiver to a second transceiver via a number of interconnected network node devices, wherein in order to set up a second data connection between first and second transceivers there is sent from the first transceiver to a network node device connected to the first transceiver a data connection setup signaling signal in which information referring to the desired course of the second data connection is included.

The second data connection preferably runs entirely or partially disjointly with respect to the first data connection (that is to say, for example, entirely or partially via another path, or other pipes, optical conductor bundles, optical conductors, etc.)

If disturbances occur on the first data connection (for example, because the appropriate pipe, the appropriate optical conductor bundle, the appropriate optical conductor has been mechanically damaged), the data transmission can be switched over quickly from the first data connection to the second (undisturbed) data connection.

Additional features and advantages of the present invention are described in, and will be apparent from, the following Detailed Description of the Invention and the Figures.

### BRIEF DESCRIPTION OF THE FIGURES

FIG. 1 shows a schematic of an optical communication network in accordance with a first exemplary embodiment of the present invention.

FIG. 2 shows a schematic of the time sequence of signaling signals exchanged between the subscriber line shown in FIG. 1 and the first network node shown in FIG. 1.

FIG. 3 shows a schematic of the time sequence of signaling signals exchanged in the case of an alternative second exemplary embodiment of the present invention between a subscriber line and a network node.

FIG. 4 shows a schematic of an optical communication network in accordance with a further exemplary embodiment of the present invention.

FIG. 5 shows a schematic of the time sequence of signaling signals exchanged between the subscriber line shown in FIG. 4 and the first or sixth network node shown in FIG. 4.

### DETAILED DESCRIPTION OF THE INVENTION

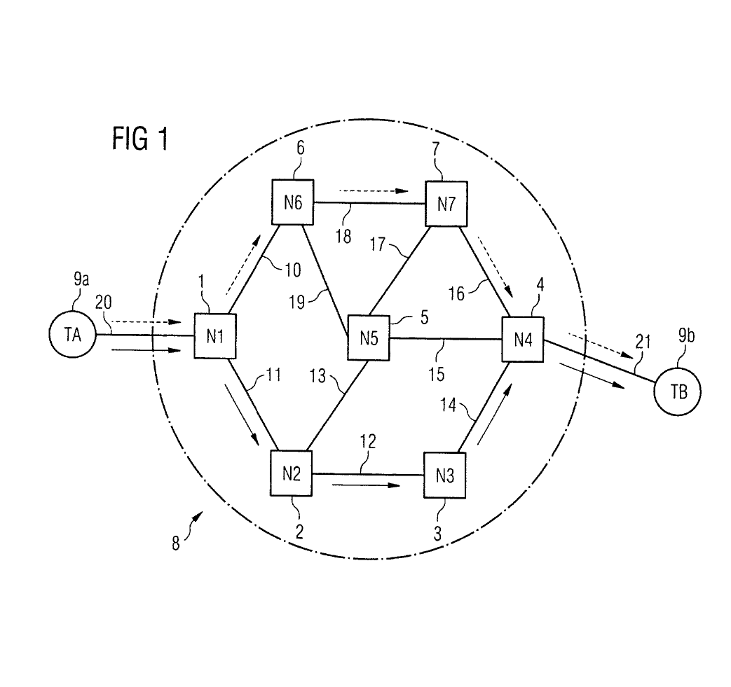

In accordance with FIG. 1, an optical communication network or optical transport network (OTN) 8 in accordance with a first exemplary embodiment of the present invention has a multiplicity of network nodes 1, 2, 3, 4, 5, 6, 7 that are interconnected via a network of optical conductor bundles 10, 11, 12, 13, 14, 15, 16, 17, 18, 19.

For example, a first optical conductor bundle 11 runs from the first network node 1 to the second network node 2, from where a second optical conductor bundle 12 runs to the third, and a third optical conductor bundle 13 to the fifth network node 5. In a corresponding way, for example, the fourth network node 4 is connected to the third network node 3 via a fourth optical conductor bundle 14, to the fifth network node 5 via a fifth optical conductor bundle 15 and to the seventh network node 7 via a sixth optical conductor bundle 16. Furthermore, a seventh optical conductor bundle 17 runs from the seventh network node 7 to the fifth network node 5, and an eighth optical conductor bundle 18 runs to the sixth network node 6, from which a ninth optical conductor bundle 19 runs to the fifth, and a tenth optical conductor bundle 10 runs to the first network node 1.

Instead of being connected via, in each case, a single optical conductor bundle 10, 11, 12, 13, 14, 15, 16, 17, 18, 19, the individual network nodes 1, 2, 3, 4, 5, 6, 7 also can be respectively connected, for example, via a number of parallel optical conductor bundles. In each case, one or more parallel optical conductor bundles are located in one or more pipes laid between the individual network nodes 1, 2, 3, 4, 5, 6, 7 (for example, partially underground).

Each optical conductor bundle 10, 11, 12, 13, 14, 15, 16, 17, 18, 19 has one or more optical conductors.

A first network subscriber line (TA) 9a is connected via a first optical conductor 20 (or via a further optical conductor bundle) to the first network node 1, and a second network subscriber line (TB) 9b is connected via a second optical conductor 21 (or via a further optical conductor bundle) to the fourth network node 4.

A WDM (wavelength division multiplex) data transmission method can be used, for example, for the purpose of data transmission between the first network subscriber line 9a and the second network subscriber line 9b (and vice versa). In this case, a pulsed optical binary signal, for example, fed into the optical conductor 20 by the network subscriber line 9a is firstly transmitted to the first network node 1, then to the fourth network node 4 with the interposition of various further network nodes, and from there to the second subscriber line 9b via the second optical conductor 21.

A number of various, pulsed optical binary signals (which apart from data transmission between the first and the second subscriber line 9a, 9b, for example, serve, for example, for data transmission between a number of further subscriber lines that are not shown here) can be transmitted in each of the optical conductors contained in the optical conductor bundles 10, 11, 12, 13, 14, 15, 16, 17, 18, 19 switched between the individual network nodes 1, 2, 3, 4, 5, 6, 7.

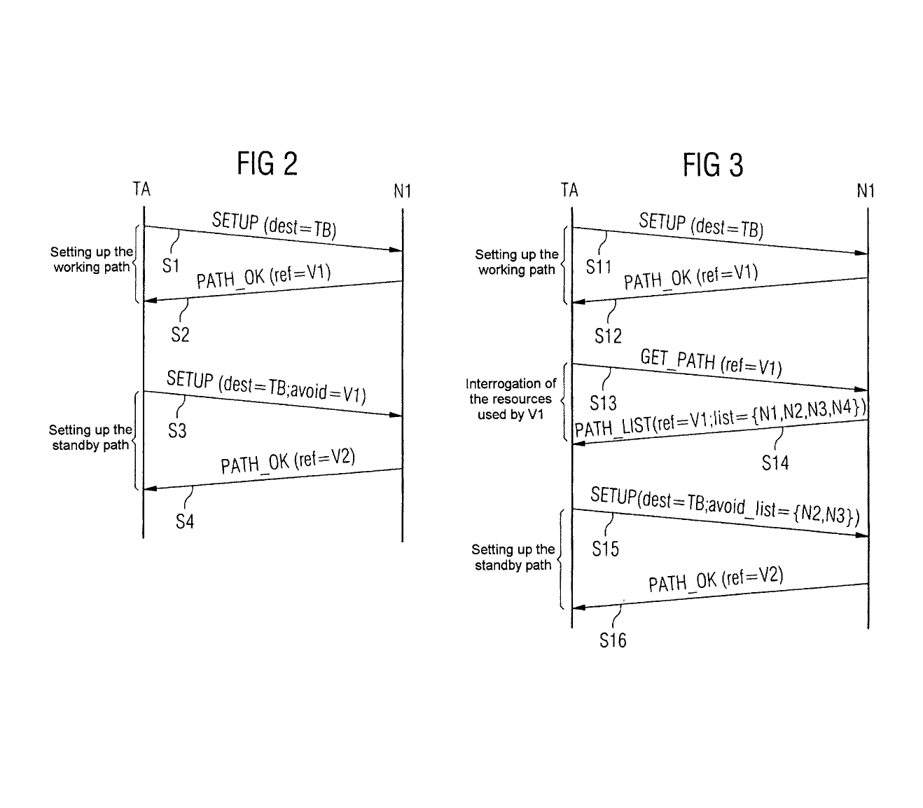

In accordance with FIG. 2, a first signaling signal S1 (SETUP (dest=TB)) is sent from the first subscriber line (TA) 9a to the first network node (N1) 1 via appropriate optical binary pulses transmitted via the optical conductor 20, in order to set up a (first, unassured “working”) data connection between a first and second subscriber line 9a or 9b. Included in this (connection setup request) signaling signal S1 there is an identifier TB that identifies the destination subscriber line (TB) 9b or the optical network address thereof.

Thereupon, in the first network node 1, a network node control device (not illustrated) selects a connection identifier (here: V1) (not yet allocated) identifying the connection to be set up, and stores it in a network node storage device (likewise not illustrated). The first network nodes N1 (or the network node control device) then selects one of the network nodes connected to the first network node 1 as that network node via which the connection is to be extended (here: the second network node 2). Thereupon, an identifier (or the network address thereof) assigned to this network node 2 is stored under assignment to the above-named connection identifier V1, in the network node storage device of the first network node 1. The next step is for the network node control device to cause a further signaling signal, corresponding to the above-named signaling signal S1, to be sent from the first network node 1 via the optical conductor bundle 11 to the selected second network node 2, which includes, inter alia, the above-named identifier TB identifying the destination subscriber line (TB), as well as the above-named connection identifier V1.

The connection identifier V1 is stored in a storage device (not illustrated) of the second network node 2. In a network node control device (likewise not illustrated), for the purpose of extending the “working” data connection one of the network nodes (here: the third network node 3) connected to the second network node 2 is selected in a network node control device (likewise not illustrated) in a corresponding way as in the first network node 1, and an identifier (or the network address thereof) assigned to this network node 3 is stored with assignment to the above-named connection identifier V1 in the network node storage device. The next step is for the network node control device to cause a further signaling signal corresponding to the above-named signaling signal SETUP (dest=TB) to be sent from the second network node 2 to the selected third network node 3, etc.

In this way, a “working” data connection, routed via the path TA-N1-N2-N3-N4-TB, is set up successively between the first subscriber line 9a and the second subscriber line 9b (illustrated in the representation in accordance with FIG. 1 by the arrows consisting of dotted lines).

If the connection has been set up successfully as far as the second subscriber line 9b, this is communicated to the fourth network node 4 from the second subscriber line 9b via a corresponding signaling signal sent via the optical conductor 21, which relays this communication via a further connection setup confirmation signaling signal to the third network node 3 which, for its part, sends a corresponding connection setup confirmation signaling signal directly to the second network node 2, which sends a corresponding signal to the first network node 1.

The latter then sends the connection setup confirmation signaling signal S2 (PATH_OK (ref=V1)), shown in FIG. 2, via the optical conductor 20 to the first subscriber line 9a which, inter alia, includes the above-named connection identifier V1. The latter is stored in a subscriber terminal storage device (not illustrated) under the control of a control device (likewise not illustrated) of the first subscriber line 9a.

Thereupon, the subscriber line control device causes, in addition to the above-named “working” data connection routed via the path TA-N1-N2-N3-N4-TB, a further “standby” data connection routed via a “standby” path to be set up to the second subscriber line 9b (illustrated in the representation in accordance with FIG. 1 by arrows consisting of dashed lines).

The “standby” path is intended to be disjoint relative to the above-named “working” path; that is to say, in the case of the two connections the aim is to make use in each case of different paths between the individual network nodes 1, 2, 3, 4, 5, 6, 7 (path diversity, illustrated in FIG. 1 by the arrows represented there). Alternatively, or in addition, the aim is for the “standby” data connection to be distinguished in another way from the “working” data connection: for example, the path between two network nodes can certainly be identical in the case of both connections, but the aim here is to use in each case two different optical conductor bundles 10, 11, 12, 13, 14, 15, 16, 17, 18, 19 or optical conductors which connect the same network nodes 1, 2, 3, 4, 5, 6, 7 and are arranged in different pipes (duct diversity). Alternatively, or in addition, it is certainly possible to make use of the same pipes in the case of both connections between two network nodes, but of different optical conductor bundles 10, 11, 12, 13, 14, 15, 16, 17, 18, 19 arranged in the same pipes or, for example, of the same optical conductor bundle but different optical conductors contained therein (fiber diversity).

Alternatively, or in addition, the “working” and the “standby” data connection can, for example, also run respectively through different buildings (building diversity).

In order to set up the “standby” data connection between first and second subscriber lines 9a, 9b, in accordance with FIG. 2 appropriate optical binary pulses are used to send an appropriate, further signaling signal S3 (SETUP (dest=TB; avoid=V1)) to the first network node (N1) from the first subscriber line (TA) 9a via the optical conductor 20. Included in this (standby connection setup request) signaling signal S3 is the identifier TB which identifies the destination subscriber line (TB) 9b, or the optical network address thereof, as well as the identifier V1 identifying the “working” data connection set up. As is explained below, the control devices of the network nodes of the optical communication network 8 are capable, on the basis of the specification of the “working” data connection or the identifier V1 thereof, of making a “standby” data connection, in the case of which use is made of a data path that is disjoint relative to the data path used in the “working” connection.

After reception of the standby connection setup request signaling signal S3, a connection identifier (here: V2) identifying the “standby” data connection to be set up is selected in the first network node 1 by the network node control device thereof, and stored in the corresponding network node storage device. The first network node N1 (or the network node control device) then selects one of the network nodes connected to the first network node 1 as that network node via which the “standby” data connection is to be extended (here: the sixth network node 6), specifically in such a way that the “standby” path resulting thereby is disjoint relative to the above-named “working” path (that is to say here: that the “standby” data connection is switched further via another network node than the “working” data connection). This is possible because, as explained above, the network node used for the “working” data connection (here: the second network node 2) is stored in the network node under assignment to the connection identifier V1 identifying the “working” data connection.

(Note: if, alternatively, or in addition, the “working” and the “standby” data connections are to be, for example, diverse in terms of ducts and/or fibers, during setting up of the “working” data connection under assignment to the connection identifier V1 information is stored alternatively or in addition with reference to the respectively used pipe, and/or the respectively used optical conductor bundle and/or optical conductor in the storage device of the first network node, and different pipes, optical conductor bundles or optical conductors are used for relaying the “standby” data connection for this purpose).

The identifier (or network address thereof) assigned to the selected sixth network node 6 is stored under assignment to the above-named connection identifier V2 in the network node storage device of the first network node 1.

The next step is for the network node control device to cause a further standby connection setup request signaling signal corresponding to the above-named signaling signal S3 to be sent from the first network node 1 via the optical conductor bundle 10 to the selected sixth network node 6, which signal includes, inter alia, the above-named identifier TB identifying the destination subscriber line (TB), the connection identifier V2 identifying the “standby” data connection, and the identifier V1 identifying the set-up “working” data connection.

The connection identifier V2 is stored in a storage device (not illustrated) of the sixth network node 6. One of the network nodes (here: the seventh network node 7) connected to the sixth network node 6 is then selected in a network node control device (likewise not illustrated) in a corresponding way as in the first network node 1 for the purpose of extending the “standby” data connection, this being done, specifically, such that the “standby” path thereby produced is disjoint with reference to the above-named “working” path (that is to say here: that the “standby” data connection is switched further via another network node than the “working” data connection). It is firstly checked for this purpose whether the connection identifier V1 identifying the “working” data connection is stored in the network node storage device (that is to say the “working” data connection is routed via the sixth network node 6), and if so, via which network node the “working” data connection has been relayed from the network node 6. The corresponding network node is then not used in switching the “standby” data connection further.

The identifier (or network address thereof) assigned to the selected seventh network node 7 is stored under assignment to the above-named connection identifier V2 in the network node storage device of the sixth network node 6.

The next step is for the network node control device to cause a further standby connection setup request signaling signal corresponding to the above-named signaling signal S3 to be sent from the sixth network node 6 to the selected seventh network node 7.

In this way, a “standby” data connection, routed via the path TA-N1-N6-N7-N4-TB, is set up successively between the first subscriber line 9a and the second subscriber line 9b, and is disjoint with reference to the “working” data connection.

If the connection has been set up successfully as far as the second subscriber line 9b, this is communicated to the fourth network node 4 from the second subscriber line 9b via a signaling signal that is sent via the optical conductor 21 and relays this communication via a further standby connection setup confirmation signaling signal to the seventh network node 7, which, for its part, sends a corresponding standby connection setup confirmation signaling signal, which is directed to the sixth network node 6 and sends a corresponding signal to the first network node 1.

The latter then sends the standby connection setup confirmation signaling signal S4 (PATH_OK (ref=V2)) shown in FIG. 2 via the optical conductor 20 to the first subscriber line 9a, which signal includes, inter alia, the above-named connection identifier V2. The latter is stored in the subscriber line storage device under the control of the subscriber line control device of the first subscriber line 9a.

During emission of the actual useful data, the connection identifiers V1, V2 are used by the subscriber line 9a to identify the connection respectively to be used. Alternatively, the useful data also can be transmitted without specifying the connection identifiers V1, V2, since an implicit assignment between a connection and a wavelength on a specific optical conductor is given in the case of the present circuit switching center.

The above-named “standby” data connection can, for example, be used for data transmission by the subscriber line 9a only when disturbances occur on the “working” data connection (or the disturbances on the “working” data connection become too large). It is thereby possible, in the case of (strong) disturbances occurring on the “working” data connection, to switch the data transmission over quickly to the “standby” data connection. Alternatively, it is possible, for example, to transmit the same data in parallel via the “working” and the “standby” data connections, and to measure the bit error rates respectively occurring during the transmission. On the basis of the respectively occurring bit error rates, it is then decided whether the data sent via the “working” data connection or the data sent via the “standby” data connection are to be regarded as valid on the second subscriber line 9b. In the case of a further alternative, various data can be sent via the “working” data connection and via the “standby” data connection. Therefore, the data transmission rates between first and second subscriber lines 9a and 9b can be increased. It can be provided, in the case of both alternatives, for the data transmission to be switched over completely to the respective other data connection in the event of (excessively strong) disturbances on one of the two data connections. In this case, an additional protocol must be used for handling the use of the channels.

In an alternative, second exemplary embodiment of the present invention, an optical communication network is constructed in a fashion correspondingly similar to the communication network 8 shown in FIG. 1.

In accordance with FIG. 3, a first signaling signal S11 (SETUP (dest=TB)) is sent, in a fashion corresponding to the first exemplary embodiment, from the first subscriber line (TA) 9a via appropriate optical binary pulses via the optical conductor 20 to the first network node (N1)1, in order to set up a (unassured) “working” data connection between a first and second subscriber line 9a, 9b. Included in this (connection setup request) signaling signal S11 is the identifier TB which identifies the destination subscriber line (TB) 9b or the optical network address thereof. The successive setup of a “working” data connection, routed via the path TA-N1-N2-N3-N4-TB, from the first to the second subscriber line 9b is thereby caused, in a correspondingly similar way to the first exemplary embodiment (illustrated in the representation in accordance with FIG. 1 by the arrows consisting of continuous lines).

After the first network node 1 has received the above-named connection setup request signaling signal S11, a control device (not illustrated) of the first network node 1 selects a connection identifier (here: V1) identifying the connection to be set up, and stores it in a network node storage device (not illustrated). Thereupon, the connection is switched further via corresponding further (connection setup request) signaling signals to the second network node 2, from there to the third and fourth network nodes 3, 4 and finally to the second subscriber line 9b.

If the “working” data connection has been set up successfully, this is communicated to the fourth network node 4 from the second subscriber line 9b via a corresponding signaling signal that relays this communication via a further connecting setup confirmation signaling signal to the third network node 3 which, for its part, sends a connection setup confirmation signaling signal, directed to the second network node 2, that sends a corresponding signal to the first network node 1.

The latter then sends the connection setup confirmation signaling signal S12 (PATH_OK (ref=V1)) shown in FIG. 3 via the optical conductor 20 to the first subscriber line 9a, which includes, inter alia, the above-named connection identifier V1. The latter is stored under the control of a control device (not illustrated) of the first subscriber line 9a in a subscriber line storage device (not illustrated).

Thereupon, the subscriber line control device causes, in addition to the above-named “working” data connection routed via the path TA-N1-N2-N3-N4-TB, a further “standby” data connection routed via a “standby” path to be set up to the second subscriber line 9b (illustrated in the representation in accordance with FIG. 1 by arrows consisting of dashed lines).

The “standby” path is to be disjoint relative to the above-named “working” path (path diversity). Alternatively, or in addition, in a fashion corresponding to the first exemplary embodiment, the “standby” data connection still may be distinguished in another way from the “working” data connection, for example, with regard to the pipes, optical conductor bundles, optical conductors, etc, used.

By contrast with the communication network in accordance with the above-explained first exemplary embodiment of the present invention, the communication network in accordance with the second exemplary embodiment is not independently capable, on the basis of the specification of the “working” data connection identifier V1, of independently making a “standby” data connection that is disjoint relative to the “working” data connection (for example, because the “standby” data connection is to be routed via a path of another operating company and/or because, by contrast with the first exemplary embodiment, information referring to the path, optical conductor bundle, optical conductor, etc. used for the “working” data connection is stored decentrally in the communication network, for example, in the storage devices assigned to the individual network nodes).

Before the setting up of the “standby” data connection between first and second subscriber lines 9a, 9b, in accordance with FIG. 3, a signaling signal S13 (GET_PATH (ref=V1)) is firstly sent from the first subscriber line (TA) 9a to the first network node (N1) 1 via optical binary pulses transmitted via the optical conductor 20. This serves the purpose of interrogating information stored in the storage device of the first network node 1 (or elsewhere in the communication network) referring to the resources used by the “working” data connection (that is to say, referring to the respectively used “working” path, or the respectively used pipes, optical conductor bundles, optical conductors).

Included, inter alia, in the (resource interrogation) signaling signal S13 is the identifier V1 identifying the “working” data connection set up.

If the first network node 1 receives the resource interrogation signaling signal S13, its control device reads out the above-named information, stored in the network node storage device, referring to the resources used by the “working” data connection (for example, the identifiers of the network nodes via which the “working” path is routed or the optical network addresses thereof).

Thereupon, in accordance with FIG. 3, a further signaling signal S14 (PATH_LIST (ref=V1; list={N1, N2, N3, N4})) is sent to the first subscriber line 9a from the network node 1 via the optical conductor 20. Apart from the identifier V1 identifying the “working” data connection, this signal includes, inter alia, a list with the identifiers of the network nodes via which the “working” path is routed.

After reception of the resource communication signaling signal S14, the control device of the first subscriber line 9a removes from the network node identifier list that identifier which is assigned to the network node to which the first subscriber line 9a is connected (here: the first network node 1), as well as that identifier which is assigned to the network node to which the second subscriber line 9a is connected (here: the fourth network node 4).

In accordance with FIG. 3, a further signaling signal S15 (SETUP (dest=TB; avoid list={N2, N3})) is then sent from the first subscriber line (TA) 9a to the first network node (N1) 1 via optical binary pulses transmitted via the optical conductor 20 in order to set up the “standby” data connection between first and second subscriber lines 9a, 9b. Included in this (standby connection setup request) signaling signal S15 is the identifier TB that identifies the destination subscriber line (TB) 9b or the optical network address thereof, as well as the resources to be avoided when setting up the “standby” data connection (here: the “working” path identified by the second and third network nodes 2, 3).

After reception of the standby connection setup request signaling signal S15, a connection identifier (here: V2) identifying the “standby” data connection to be set up is selected in the first network node 1 by the network node control device, and stored in the network node storage device. The first network node N1 (or the network node control device) then selects one of the network nodes connected to the first network node 1 as that network node via which the “standby” data connection is to be extended (here: the sixth network node 6), specifically in such a way that the “standby” path resulting thereby is disjoint relative to the above-named “working” path (that is to say here: that the next network node used is not included in the list, received by the first subscriber line 9a, of network nodes 2, 3 to be avoided).

The next step is for the network node control device to cause a further standby connection setup request signaling signal S15 to be sent from the first network node 1 to the selected sixth network node 6, which signal includes, inter alia, the abovementioned identifier TB, identifying the destination subscriber line (TB), the connection identifier V2, identifying the “standby” data connection, as well as the resources to be avoided when setting up the “standby” data connection.

In a network node control device (not illustrated), a network node connected to the sixth network node 6 is then selected in a corresponding way as in the first network node 1 for the extension of the “standby” data connection as that network node via which the “standby” data connection is to be extended (here: the seventh network node 7), and, specifically, in turn, such that the “standby” path resulting thereby is disjoint relative to the above-named “working” path (that is to say here: that the next node used is not included in the above-named list of network nodes 2, 3 to be avoided).

In this way, a “standby” data connection (illustrated in the representation in accordance with FIG. 1 by the arrows consisting of dashed lines), routed via the path TA-N1-N6-N7-N4-TB, is set up between the first subscriber line 9a and the second subscriber line 9b, and is disjoint relative to the “working” data connection.

If the connection has been set up successfully as far as the second subscriber line 9b, this is communicated from the second subscriber line 9b via an appropriate signaling signal to the fourth network node 4 which relays this communciation via a further standby connection setup confirmation signaling signal to the seventh network node 7 which, for its part, sends a standby connection setup confirmation signaling signal that is directed to the sixth network node 6 and sends a corresponding signal to the first network node 1.

The latter then sends the standby connection setup confirmation signaling signal S16 (PATH_OK (ref=V2)) shown in FIG. 3 via the optical conductor 20 to the first subscriber line 9a, which signal includes, inter alia, the above-named connection identifier V2. The latter is stored in the subscriber line storage device under the control of the subscriber line control device of the first subscriber line 9a, and is used, during emission of the actual useful data, to identify the connection respectively to be used.

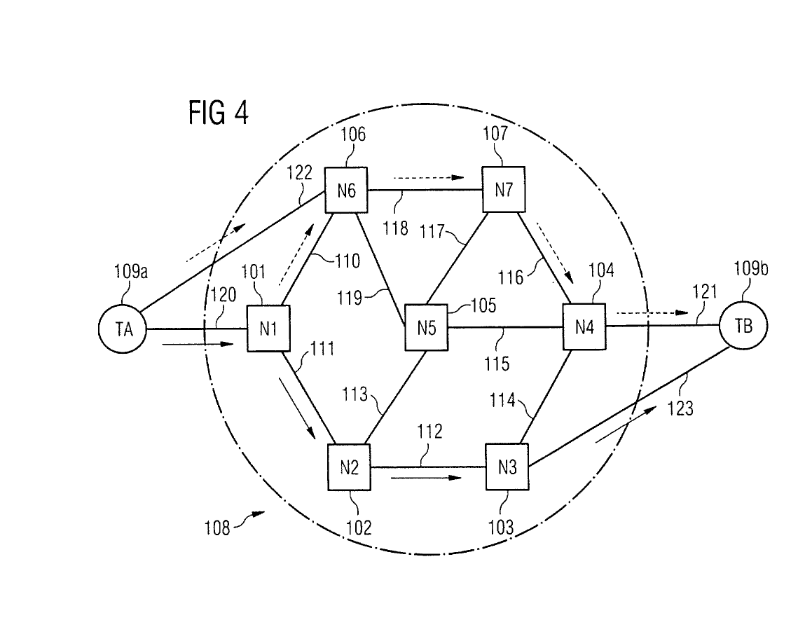

It was assumed in the case of the exemplary embodiments described in conjunction with FIG. 1 (and of the following ones in conjunction with FIG. 4) that the actual useful data transmitted via the “working” or the “standby” data connection, and the signaling information (for example, the signals S1, S2, S3, S4) are respectively transmitted via corresponding optical pulses, and respectively transmitted via one and the same optical conductor. In the case of alternative exemplary embodiments, by contrast, by comparison with the useful information, the signaling information is transmitted via separate optical conductors, and/or via separate paths. It is equally conceivable to transmit the signaling information via a separate, electrical transmission network. Likewise, instead of exchanging the signaling information between the relevant network nodes, as illustrated, it is also possible to do so between the respectively relevant network nodes and one or more central network nodes in which the signaling information is processed.

In accordance with FIG. 4, an optical communication network or optical transport network (OTN) 108 in accordance with a third exemplary embodiment of the present invention has a number of network nodes 101, 102, 103, 104, 105, 106, 107 as well as a multiplicity of further network nodes (not illustrated here).

The network nodes 101, 102, 103, 104, 105, 106, 107 are interconnected via a network of, in each case, one or more optical conductor bundles 110, 111, 112, 113, 114, 115, 116, 117, 118, 119. Each optical conductor bundle 110, 111, 112, 113, 114, 115, 116, 117, 118, 119 has one or more optical conductors.

A first network subscriber line (TA) 109a is connected via a first optical conductor 120 to the first network node 101 and a second network subscriber line (TB) 109b is connected via a second optical conductor 121 to the fourth network node 104. Moreover, by contrast with the above-explained first and second exemplary embodiments, the first network subscriber line (TA) 109a is additionally connected via a third optical conductor 122 to the sixth network node 106, and the second network subscriber line (TB) 109b is connected via a fourth optical conductor 123 to the third network node 103.

In a way corresponding to the exemplary embodiments explained above, use is made, for example, of a WDM data transmission method for the purpose of transmitting data between the first network subscriber line 109a and the second network subscriber line 109b (and vice versa)

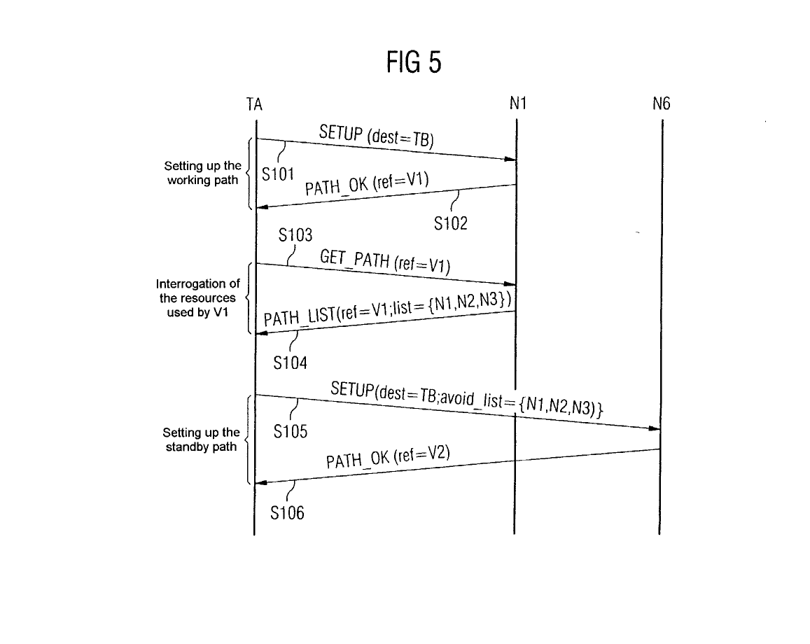

In accordance with FIG. 5, a first signaling signal S101 (SETUP (dest=TB))is sent in a fashion corresponding to the first and second exemplary embodiments from the first subscriber line (TA) 109a to the first network node (N1) 101 via appropriate optical binary pulses, in order to set up a (unassured) “working” data connection between the first and second subscriber lines 109a and 109b. Included in this (connection setup request) signaling signal S101 there is an identifier TB that identifies the destination subscriber line (TB) 109b or the optical network address thereof. Thereby, in a corresponding fashion similar to the first and second exemplary embodiments, the successive setup of a “working” data connection routed via the path TA-N1-N2-N3-TB, from the first to the second subscriber line 109b is caused (illustrated in the representation in accordance with FIG. 1 by the arrows consisting of continuous lines).

After the first network node 101 has received the above-named connection setup request signaling signal S101, a control device (not illustrated) of the first network node 101 selects a connection identifier (here: V1) identifying the connection to be set up, and stores it in a network node storage device (not illustrated). Thereupon, the connection is switched further via corresponding further (connection setup request) signaling signals to the second and third network nodes 101, 103 and from there to the second subscriber line 109b.

If the “working” data connection has been set up successfully, this is communicated to the third network node 103 from the second subscriber line 109b via an appropriate signaling signal, which relays this communication via a further connection setup confirmation signaling signal to the second network node 102 which, for its part, sends a corresponding connection setup confirmation signaling signal that is directed to the first network node 101.

The latter then sends the connection setup confirmation signaling signal S102 (PATH_OK (ref=V1)) shown in FIG. 5 via the optical conductor 120 to the first subscriber line 109a, which includes, inter alia, the above-named connection identifier V1. The latter is stored under the control of a control device (not illustrated) of the first subscriber line 109a in a subscriber line storage device (not illustrated).

Thereupon, the subscriber line control device causes, in addition to the above-named “working” data connection, routed via the path TA-N1-N2-N3-TB, a further “standby” data connection, routed via a “standby” path, to be set up to the second subscriber line 109b (illustrated in the representation in accordance with FIG. 1 by arrows consisting of dashed lines).

The “standby” path is to be disjoint relative to the above-named “working” path (path diversity). Alternatively, or in addition, in a fashion corresponding to the first or second exemplary embodiment, the “standby” data connection is to be distinguished from the “working” data connection, for example, with regard to the pipes, optical conductor bundles, optical conductors, etc., used.

In accordance with FIG. 5, a signaling signal S103 (GET_PATH (ref=V1)) is firstly sent via appropriate optical binary pulses to the first network node (N1) 101 from the first subscriber line (TA) 109a via the optical conductor 120 for the setting up of the “standby” data connection between first and second subscriber lines 109a, 109b. This serves the purpose of interrogating information stored in the storage device of the first network node 101 (or elsewhere in the communication network) referring to the resources used by the “working” data connection (that is to say, referring to the respectively used “working” path, or the respectively used pipes, optical conductor bundles, optical conductors, etc.).

Included, inter alia, in the (resource interrogation) signaling signal S103 is the identifier V1 identifying the “working” data connection setup.

If the first network node 101 receives the resource interrogation signaling signal S103, its control device reads out the above-named information, stored in the network node storage device, referring to the resources used by the “working” data connection (for example, the identifiers of the network nodes via which the “working” path is routed or the optical network addresses thereof).

Thereupon, in accordance with FIG. 5, a further signaling signal S104 (PATH_LIST (ref=V1; list={N1, N2, N3,})) is sent to the first subscriber line 109a from the network node 101 via the optical conductor 120. Apart from the identifier V1 identifying the “working” data connection, this signal includes, inter alia, a list with the identifiers of the network nodes via which the “working” path is routed.

In accordance with FIG. 5, a further signaling signal S105 (SETUP (dest=TB; avoid_list={N1, N2, N3})) is sent to the sixth network node (N6) 106 from the first subscriber line (TA) 9a via corresponding optical binary pulses via the optical conductor 122, after reception of the resource communication signaling signal S104, in order to build up the “standby” data connection between first and second subscriber lines 109a, 109b. Included in this (standby connection setup request) signaling signal S105 is the identifier TB that identifies the destination subscriber line (TB) 109b or the optical network address thereof, as well as the resources to be avoided when setting up the “data connection” (here: the “working” path identified by the first, second and third network nodes 101, 102, 103).

After reception of the standby connection setup request signaling signal S105, a connection identifier (here: V2) identifying the “standby” data connection to be set up is generated in the sixth network node 6 by the corresponding network node control device, and stored in the network node storage device. The sixth network node 106 (or the network node control device) then selects one of the network nodes connected to the sixth network node 106 as that network node via which the “standby” data connection is to be extended (here: the seventh network node 107), specifically in such a way that the “standby” path resulting thereby is disjoint relative to the above-named “working” path (that is to say here: that the next node used is not included in the list, received by the first subscriber line 109a, of network nodes 101, 102, 103 to be avoided).

The next step is for the network node control device of the sixth network node 106 to cause a further standby connection setup request signaling signal corresponding to the above-named signaling signal S105 to be sent from the sixth network node 106 to the selected seventh network node 107, which signal includes, inter alia, the above-named identifier TB, identifying the destination subscriber line (TB), the connection identifier V2, identifying the “standby” data connection, as well as the resources to be avoided when setting up the “standby” data connection.

In a network node control device of the seventh network node 107 (not illustrated), a network node connected to the seventh network node 107 is then selected in a corresponding way as in the sixth network node 106 for the extension of the “standby” data connection as that network node via which the “standby” data connection is to be extended (here: the fourth network node 104), and, specifically, in turn, such that the “standby” path resulting thereby is disjoint relative to the above-named “working” path (that is to say here: that the next node used is not included in the above-named list of network nodes 101, 102, 103 to be avoided).

In this way, a “standby” data connection, routed via the path TA-N6-N7-N4-TB, is set up between the first subscriber line 109a and the second subscriber line 109b, and is disjoint relative to the “working” data connection.

If the connection has been set up successfully as far as the second subscriber line 109b, this is communicated to the fourth network node 104 from the second subscriber line 109b via a signaling signal, which relays this communication via a further standby connection setup confirmation signaling signal to the seventh network node 107, which, for its part, sends a standby connection setup confirmation signaling signal that is directed to the sixth network node 106.

The latter then sends the standby connection setup confirmation signaling signal S106 (PATH_OK (ref=V2)) shown in FIG. 5 via the optical conductor 122 to the first subscriber line 109a, which signal includes, inter alia, the above-named connection identifier V2. The latter is stored in the subscriber line storage device under the control of the subscriber line control device of the first subscriber line 109a, and is used, during emission of the actual useful data, to identify the connection respectively to be used.

Although the present invention has been described with reference to specific embodiments, those of skill in the art will recognize that changes may be made thereto without departing from the spirit and scope of the present invention as set forth in the hereafter appended claims.

1. An optical communication network, comprising:
first and second transceivers; and
a plurality of interconnected network node devices;
wherein optical signals are transferred via a first data connection from the first transceiver to the second transceiver via the plurality of interconnected network node devices; and
wherein, for setting up a second data connection between the first transceiver and the second transceiver, a data connection setup signaling signal is sent from the first transceiver to one corresponding network node device connected to the first transceiver in which information referring to the desired course of the second data connection is included.

2. An optical communication network as claimed in claim 1, wherein the information includes an identifier identifying the first data connection.

3. An optical communication network as claimed in claim 2, wherein the information identifies that the second data connection is to run at least partially disjointly relative to the first data connection.

4. An optical communication network as claimed in claim 3, wherein the second data connection is to run partially via another path other than the first data connection.

5. An optical communication network as claimed in claim 3, wherein the second data connection is to run at least partially via other optical conductor bundles than the first data connection.

6. An optical communication network as claimed in claim 3, wherein the second data connection is to run at least partially via optical conductors other than the first data connection.

7. An optical communication network as claimed in claim 1, wherein the information includes information referring to a path used by the first data connection that is to be avoided by the second data connection.

8. An optical communication network as claimed in claim 1, wherein the information includes information referring to optical conductor bundles or optical conductors used by the first data connection that are to be avoided by the second data connection.

9. An optical communication network as claimed in claim 1, wherein the first transceiver is a subscriber line unit.

10. An optical communication network as claimed in claim 9, wherein the subscriber line unit is coupled to a single network node device.

11. An optical communication network as claimed in claim 9, wherein the subscriber line unit is coupled to a plurality of network node devices.

12. An optical communication network as claimed in claim 1, wherein the second transceiver is a subscriber line unit.

13. An optical communication network as claimed in claim 12, wherein the subscriber line unit is coupled to a single network node device.

14. An optical communication network as claimed in claim 12, wherein the subscriber line unit is coupled to a plurality of network node devices.

15. An optical communication network as claimed in claim 1, wherein the second data connection is used as standby data connection.

16. An optical communication network as claimed in claim 15, wherein the second data connection is used as a standby data connection when disturbances occur on the first data connection.

17. An optical communication network as claimed in claim 1, wherein the signals transmitted via the first data connection and the second data connection are wavelength-division-multiplexed optical signals.

18. An optical communication network as claimed in claim 1, wherein the first transceiver transmits the data connection setup signaling signal via a same optical conductor or a same optical conductor bundle as useful data signals emitted by it.

19. An optical communication network as claimed in claim 1, wherein the first transceiver transmits the data connection setup signaling signal via another conductor than an electric signaling signal via an electric conductor, or than an optical signaling signal via a further optical conductor.

20. An optical communication network as claimed in claim 1, wherein a further data connection setup signaling signal is used to interrogate a list of network elements used by the first data connection, the list of network elements including network node devices, optical conductors and optical conductor bundles.

21. A subscriber line unit configured and setup as a first transceiver in an optical communication network, the network including the first transceiver and a second transceiver as well as a plurality of interconnected network node devices, wherein optical signals are transferred via a first data connection from the first transceiver to the second transceiver via the plurality of interconnected network node devices, wherein the first transceiver comprises parts for setting up a second data connection between the first transceiver and the second transceiver by sending from the first transceiver to one corresponding network node device connected to the first transceiver a data connection setup signaling signal in which information referring to a desired course of the second data connection is included.

22. An optical information transmission method, the method comprising the steps of:
providing first and second transceivers;
providing a plurality of interconnected network node devices;
transferring optical signals via a first data connection from the first transceiver to the second transceiver via the plurality of interconnected network node devices; and
setting up a second data connection between the first transceiver and the second transceiver by sending from the first transceiver to one corresponding network node device connected to the first transceiver a data connection setup signaling signal in which information referring to a desired course of the second data connection is included.
